(19) United States
(12) Patent Application Publication
(10) Pub. No.: US 2024/0264291 A1
(43) Pub. Date: Aug. 8, 2024

(54) APPARATUS AND METHOD CONTROLLING THE SAME

(71) Applicant: HL KLEMOVE CORP., Incheon (KR)

(72) Inventor: Daegyeong KIM, Suwon-si (KR)

(21) Appl. No.: 18/230,738

(22) Filed: Aug. 7, 2023

(30) Foreign Application Priority Data
Feb. 6, 2023 (KR) 10-2023-0015428

(51) Int. Cl. G01S 7/497; G01S 7/481; G01S 17/931

(52) U.S. Cl. CPC G01S 7/497; G01S 7/4813; G01S 17/931; G01S 2007/4975

(57) ABSTRACT

Disclosed herein is a driving assistance apparatus including a memory storing a program for determining a state of a LIDAR and a processor configured to execute the stored program, wherein the processor is further configured to compare data about a first reception signal received firstly after light is output from the LiDAR with reference data, and determine that the LiDAR is contaminated when an error between the data about the first reception signal and the reference data is greater than a threshold.

### CROSS-REFERENCE TO RELATED APPLICATION

This application claims the benefit of Korean Patent Application No. 10-2023-0015428, filed on Feb. 6, 2023 in the Korean Intellectual Property Office, the disclosure of which is incorporated herein by reference in its entirety.

### BACKGROUND

### 1. Field

Embodiments of the present disclosure relate to an apparatus for detecting the contamination of a Light Detection and Ranging (LiDAR) device mounted in a vehicle, and a method of controlling the same.

### 2. Description of the Related Art

In recent years, research has been actively conducted on a vehicle equipped with an advanced driver assistance system (ADAS) configured to obtain information about a status of the vehicle, a driver's status, or a surrounding environment and actively control the vehicle in response to the obtained information to reduce burden on the driver and improve stability.

For example, the ADAS mounted in the vehicle may perform a function such as a lane departure warning (LDW), lane keeping assist (LKA), high-beam assist (HBA), autonomous emergency braking (AEB), traffic sign recognition (TSR), adaptive cruise control (ACC), or blind spot detection (BSD).

In order to allow the ADAS to perform the function, it is necessary to detect nearby vehicles, obstacles, pedestrians, etc. using sensors such as a camera, a radar, and a LIDAR, and appropriately respond to a detection result.

### SUMMARY

Therefore, it is an aspect of the present disclosure to provide an apparatus for preventing performance degradation due to the contamination of a Light Detection and Ranging (LIDAR) device by determining whether the LiDAR device is contaminated in response to a signal received from the LiDAR device, and removing the contamination of the LiDAR device in response to a result of the determination, and a control method thereof.

Additional aspects of the disclosure will be set forth in part in the description which follows and, in part, will be obvious from the description, or may be learned by practice of the disclosure.

In accordance with one aspect of the present disclosure, an apparatus includes a Light Detection and Ranging (LiDAR) device with an area for detection of surroundings of a vehicle, a memory storing a program for determining a state of the LIDAR device, and a processor configured to execute the stored program. The processor further compares data about a first reception signal, which is received firstly after light is output from the LiDAR device, with reference data, and determines whether the LiDAR is contaminated based on whether an error between the data about the first reception signal and the reference data is greater than a threshold.

The memory may store, as the reference data, an intensity of a first reference reception signal received firstly after light is output from the LiDAR device in a state in which a window of the LiDAR device is not contaminated.

The processor may compare an intensity of the first reception signal with the reference data stored in the memory and determine that the window of the LiDAR device is contaminated based on an error between the intensity of the first reception signal and the reference data being greater than the threshold.

The memory may store, as the reference data, a maximum intensity and maximum width of a first reference reception signal received firstly after light is output from the LiDAR device in a state in which a window of the LiDAR device is not contaminated.

The processor may compare a maximum intensity and maximum width of the first reception signal with the reference data and determine that the window of the LIDAR device is contaminated based on at least one of an error between the maximum intensity of the first reception signal and the reference data or an error between the maximum width of the first reception signal and the reference data being greater than the threshold.

The memory may store, as the reference data, a maximum intensity of a first reference reception signal received firstly after light is output from the LiDAR device in a state in which a window of the LiDAR device is not contaminated and an width of the first reference reception signal at an intermediate intensity thereof.

The processor may compare a maximum intensity of the first reception signal and an width of the first reception signal at an intermediate intensity with the reference data and determine that the window of the LiDAR device is contaminated based on at least one of an error between the maximum intensity of the first reception signal and the reference data or an error between the width of the first reception signal at the intermediate intensity and the reference data being greater than the threshold.

The memory may store, as the reference data, a maximum intensity of a first reference reception signal received firstly after light is output from the LiDAR device in a state in which a window of the LiDAR device is not contaminated, a maximum width of the first reference reception signal, and an width of the first reference reception signal at an intermediate intensity thereof.

The processor may compare a maximum intensity of the first reception signal, a maximum width of the first reference reception signal, and an width of the first reception signal at an intermediate intensity with the reference data and determine that the window of the LiDAR device is contaminated based on at least one of an error between the maximum intensity of the first reception signal and the reference data, an error between the maximum width of the first reception signal and the reference data, or an error between the width of the first reception signal at the intermediate intensity and the reference data being greater than the threshold.

The memory may store, as the reference data, a maximum intensity of a first reference reception signal received firstly after light is output from the LiDAR device in a state in which a window of the LiDAR device is not contaminated, an width of the first reference reception signal at an intermediate intensity thereof, and an amplification time from a point in time that the first reference reception signal is amplified to a point in time that the first reference reception signal reaches the maximum intensity.

The processor may compare a maximum intensity of the first reception signal, an width of the first reception signal at an intermediate intensity thereof, and an amplification time of the first reception signal with the reference data and determine that the window of the LiDAR device is contaminated based on at least one of an error between the maximum intensity of the first reception signal and the reference data, an error between the width of the first reception signal at the intermediate intensity and the reference data, or an error between the amplification time of the first reception signal and the reference data being greater than the threshold.

The memory may store, as the reference data, at least one of a maximum intensity of a first reception signal received firstly after light is output from the LiDAR device in a state in which a window of the LiDAR device is not contaminated, a maximum width of the first reception signal, an width of the first reception signal at an intermediate intensity thereof, or an amplification time from a point in time that the first reception signal is amplified to a point in time that the first reception signal reaches the maximum intensity.

In accordance with another aspect of the present disclosure, a control method of an apparatus including a Light Detection and Ranging (LiDAR) device includes outputting light through the LiDAR device, comparing data about a first reception signal, which is received firstly after the light is output from the LiDAR device, with reference data, and determining whether the LiDAR device is contaminated based on whether an error between the data about the first reception signal and the reference data is greater than a threshold.

The control method may further include storing, as the reference data, an intensity of a first reference reception signal received firstly after the light is output from the LiDAR device in a state in which a window of the LiDAR device is not contaminated. The comparing of the data about the first reception signal with the reference data may include comparing an intensity of the first reception signal with the reference data, and the determining of whether the window of the LiDAR device is contaminated includes determining that the window of the LiDAR device is contaminated based on an error between the intensity of the first reception signal and the reference data being greater than the threshold.

The control method may further include storing, as the reference data, a maximum intensity and maximum width of a first reference reception signal received firstly after light is output from the LiDAR device in a state in which a window of the LIDAR device is not contaminated. The comparing of the data about the first reception signal with the reference data may include comparing a maximum intensity and maximum width of the first reception signal with the reference data, and the determining of whether the window of the LiDAR device is contaminated includes determining that the window of the LiDAR device is contaminated based on at least one of an error between the maximum intensity of the first reception signal and the reference data or an error between the maximum width of the first reception signal and the reference data being greater than the threshold.

The control method may further include storing, as the reference data, a maximum intensity of a first reference reception signal received firstly after light is output from the LiDAR device in a state in which a window of the LiDAR device is not contaminated and an width of the first reference reception signal at an intermediate intensity thereof. The comparing of the data about the first reception signal with the reference data may include comparing a maximum intensity of the first reception signal and an width of the first reception signal at the intermediate intensity with the reference data, and the determining of whether the window of the LiDAR device is contaminated includes determining that the window of the LiDAR device is contaminated based on at least one of an error between the maximum intensity of the first reception signal and the reference data or an error between the width of the first reception signal at the intermediate intensity and the reference data being greater than the threshold.

The control method may further include storing, as the reference data, a maximum intensity of a first reference reception signal received firstly after light is output from the LiDAR device in a state in which a window of the LiDAR device is not contaminated, a maximum width of the first reference reception signal, and an width of the first reference reception signal at an intermediate intensity thereof. The comparing of the data about the first reception signal with the reference data may include comparing a maximum intensity of the first reception signal, a maximum width of the first reception signal, or an width of the first reception signal at an intermediate intensity thereof with the reference data, and the determining of whether the window of the LiDAR device is contaminated includes determining that the window of the LIDAR device is contaminated based on at least one of an error between the maximum intensity of the first reception signal and the reference data, an error between the maximum width of the first reception signal and the reference data, or an error between the width of the first reception signal at the intermediate intensity and the reference data being greater than the threshold.

The control method may further include storing, as the reference data, a maximum intensity of a first reference reception signal received firstly after light is output from the LiDAR device in a state in which a window of the LiDAR device is not contaminated, an width of the first reference reception signal at an intermediate intensity thereof, and an amplification time from a point in time that the first reference reception signal is amplified to a point in time that the first reference reception signal reaches the maximum intensity. The comparing of the data about the first reception signal with the reference data may include comparing a maximum intensity of the first reception signal, an width of the first reception signal at an intermediate intensity thereof, and an amplification time of the first reception signal with the reference data, and the determining of whether the window of the LiDAR device is contaminated includes determining that the window of the LiDAR device is contaminated based on at least one of an error between the maximum intensity of the first reception signal and the reference data, an error between the width of the first reception signal at the intermediate intensity and the reference data, or an error between the amplification time of the first reception signal and the reference data being greater than the threshold.

The control method may further include storing, as the reference data, at least one of a maximum intensity of a first reception signal received firstly after light is output from the LiDAR device in a state in which a window of the LiDAR device is not contaminated, a maximum width of the first reception signal, an width of the first reception signal at an intermediate intensity thereof, or an amplification time from a point in time that the first reception signal is amplified to a point in time that the first reception signal reaches the maximum intensity.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a block diagram illustrating operations of a vehicle and a driving assistance apparatus included in the vehicle according to an embodiment;

FIG. 2 illustrates a field of view of each of a camera, a radar, and a LIDAR that are included in a vehicle according to an embodiment;

FIG. 3 is a diagram illustrating a configuration of a LIDAR included in a driving assistance apparatus according to an embodiment;

FIG. 4 is a diagram illustrating a configuration of a LIDAR included in a driving assistance apparatus according to another embodiment;

FIG. 5 is a flowchart of a LIDAR contamination detection method according to an embodiment;

FIG. 6 is a diagram illustrating data that may indicate characteristics of a first reception signal received by a LIDAR;

FIG. 7 is a diagram illustrating an example of a first reception signal when a window of a LIDAR is contaminated

FIG. 8 is a diagram illustrating another example of a first reception signal when a window of a LIDAR is contaminated;

FIG. 9 is a block diagram illustrating an operation of a vehicle according to an embodiment; and

FIG. 10 is a flowchart of a method of detecting the contamination of a LIDAR according to an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

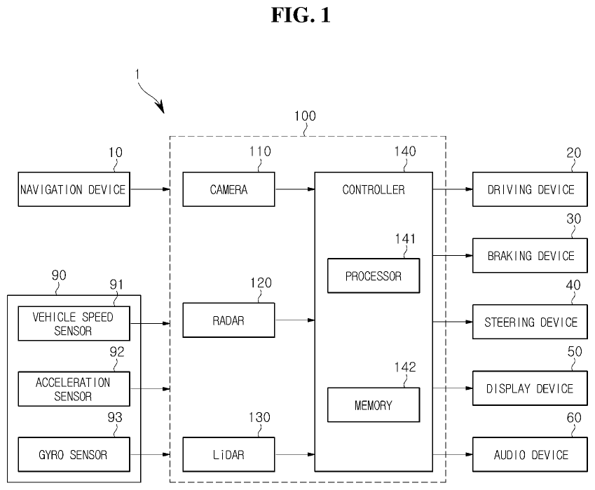

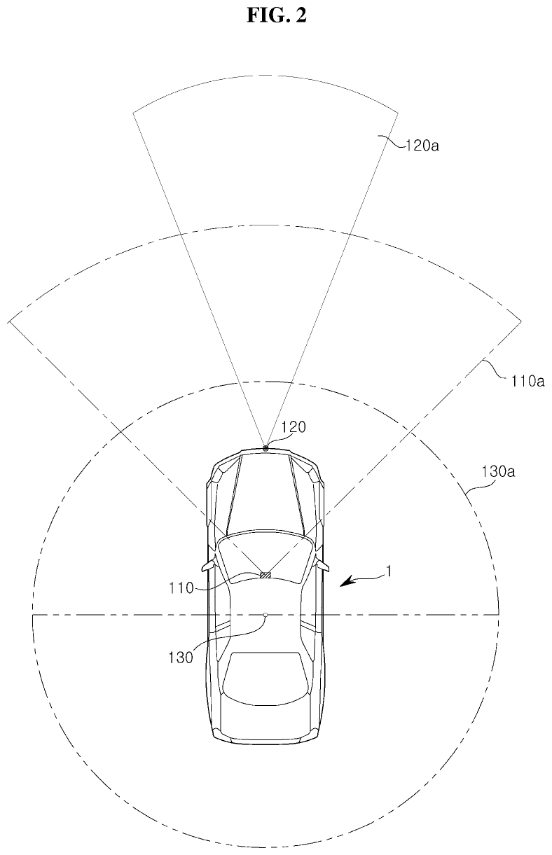

FIG. 1 is a block diagram illustrating operations of a vehicle and a driving assistance apparatus included in the vehicle according to an embodiment. FIG. 2 illustrates a field of view of each of a camera, a radar, and a LIDAR that are included in a vehicle according to an embodiment.

As shown in FIG. 1, a vehicle 1 may include a navigation device 10, a driving device 20, a braking device 30, a steering device 40, a display device 50, an audio device 60, a behavior sensor 90, and a driving assistance apparatus 100.

The navigation device 10 may generate a route to a destination input by a driver and provide the generated route to the driver. The navigation device 10 may receive global navigation satellite system (GNSS) signals from a GNSS, and identify an absolute position (coordinates) of the vehicle 1, based on the GNSS signals. The navigation device 10 may generate a route to the destination, based on the position (coordinates) of the destination input by the driver and a current position (coordinates) of the vehicle 1.

The driving device 20 generates power required to move the vehicle 1. For example, the driving device 20 may include an engine, an engine management system (EMS), a transmission, and a transmission control unit (TCU).

The engine generates power to drive the vehicle 1, and the EMS may control the engine in response to either the driver's intention to accelerate through an accelerator or a request from the driving assistance apparatus 100. The transmission decelerates and transmits power generated by the engine to a wheel, and the transmission control unit may control the transmission in response to a speed change command from the driver through a change lever and/or a request from the driving assistance apparatus 100.

Alternatively, the driving device 20 may include a driving motor, a reducer, a battery, a power control device, etc. In this case, the vehicle 1 may be implemented as an electric vehicle.

Alternatively, the driving device 20 may include all devices related to the engine and devices related to a driving motor. In this case, the vehicle 1 may be implemented as a hybrid vehicle.

The braking device 30 may decelerate the vehicle 1. For example, the braking device 30 may include a brake caliper and an electronic brake control module (EBCM). The brake caliper may decelerate or stop the vehicle 1 using friction with a brake disk.

The electronic braking control module may control the brake caliper in response to the driver's intention to brake through the brake pedal or a request from the driving assistance apparatus 100. For example, the electronic braking control module may receive a deceleration request including deceleration from the driving assistance apparatus 100, and control the brake caliper electrically or through hydraulic pressure to decelerate the vehicle 1, based on the requested deceleration.

The steering device 40 may include an electronic power steering control module (EPS). The steering device 40 may change a driving direction of the vehicle 1, and the electronic steering control module may assist an operation of the steering device 40 in response to a driver's intention to steer through a steering wheel, so that the driver may easily manipulate the steering wheel.

In addition, the electronic steering control module may control the steering device 40 in response to a request from the driving assistance apparatus 100. For example, the electronic steering control module may receive a steering request including steering torque from the driving assistance apparatus 100 and control the steering device 40 such that the vehicle 1 is steered according to the requested steering torque.

The display device 50 may include a cluster, a head-up display, a center fascia monitor, and the like, and provide a driver with various types of information and entertainment in the form of images. For example, the display device 50 may provide the driver with driving information of the vehicle 1, a warning message, and the like.

The audio device 60 may include a plurality of speakers, and provide a driver with various types of information and entertainment in the form of sound. For example, the audio device 60 may provide the driver with driving information of the vehicle 1, a warning message, and the like.

The behavior sensor 90 may include at least one of a vehicle speed sensor 91 that detects a driving speed of the vehicle 1, an acceleration sensor 92 that detects the longitudinal and lateral accelerations of the vehicle 1, or a gyro sensor 93 that detects a yaw rate, a roll rate, or a pitch rate of the vehicle 1.

The above-described components may transmit and receive data with one another through a vehicle communication network. For example, the above-described components included in the vehicle 1 may transmit and receive data with one another through a vehicle communication network such as Ethernet, media oriented systems transport (MOST), flexray, a controller area network (CAN), or a local interconnect network (LIN).

Although not shown in the drawings, the vehicle 1 according to an embodiment may further include a communication module for communication with other external devices. The communication module may wirelessly communicate with a base station or an access point (AP) and transmit and receive data with external devices through the base station or the AP.

For example, the communication module may wirelessly communicate with the AP using WiFi™ (IEEE 802.11 technology standard) or communicate with the base station using CDMA, WCDMA, GSM, long-term evolution (LTE), 5G, WiBro or the like.

In addition, the communication module may directly communicate with external devices. For example, the communication module may transmit and receive data with nearby external devices using Wi-Fi Direct, Bluetooth (IEEE 802.15.1 technology standard), ZigBee™ (IEEE 802.15.4 technology standard), or the like.

In an embodiment, the driving assistance apparatus 100 may communicate with the navigation device 10, the driving device 20, the braking device 30, the steering device 40, the display device 50, and the audio device 60 through a vehicle communication network. The driving assistance apparatus 100 may use data provided from the other components of the vehicle 1 as a basis of recognition/judgment, and transmit a control signal for control of the vehicle 1 to the other components of the vehicle 1, based on a recognition/judgement result.

The driving assistance apparatus 100 may provide a driver with various safety functions and be used for autonomous driving of the vehicle 1. For example, the driving assistance apparatus 100 may provide functions such as a lane departure warning (LDW), lane keeping assist (LKA), high-beam assist (HBA), autonomous emergency braking (AEB), traffic sign recognition (TSR), adaptive cruise control (ACC), blind spot detection (BSD), etc.

The driving assistance apparatus 100 may include a camera 110, a radar 120, a LIDAR 130, and a controller 140 to perform the above-described functions.

The controller 140, the camera 110, the radar 120, and the LiDAR 130 may be physically separated from one another. For example, the controller 140 may be installed in a housing separate from a housing of the camera 110, a housing of the radar 120, and a housing of the LiDAR 130. The controller 140 may transmit and receive data with the camera 110, the radar 120, or the LiDAR 130 through a broadband network.

Alternatively, at least some of the camera 110, the radar 120, the LiDAR 130, and the controller 140 may be unified. For example, the camera 110 and the controller 140 may be provided in the same housing, the radar 120 and the controller 140 may be provided in the same housing, or the LiDAR 130 and the controller 140 may be provided in the same housing.

The camera 110 may photograph surroundings of the vehicle 1 to obtain image data of the surroundings of the vehicle 1. For example, the camera 110 may be installed in a front windshield of the vehicle 1 as shown in FIG. 2, and have a forward field of view 110a of the vehicle 1.

The camera 110 may include a plurality of lenses and an image sensor. The image sensor may include a plurality of photodiodes that convert light into an electrical signal, and the plurality of photodiodes may be arranged in a two-dimensional (2D) matrix.

The image data may include information about other vehicles, pedestrians, bicycles or lane lines (markers identifying lanes) near the vehicle 1.

The driving assistance apparatus 100 may include a processor that processes image data of the camera 110, and the processor may be, for example, a component included in the camera 110 or the controller 140.

The processor may obtain image data from the image sensor of the camera 110, and detect and identify an object near the vehicle 1, based on a result of processing the image data. For example, the processor may perform image processing to generate a track corresponding to a nearby object of the vehicle 1, and classify the generated track. The processor may identify whether the track is another vehicle, a pedestrian, a bicycle, or the like, and assign identification code to the track.

The processor may transmit data about a track (or a position and classification of the track) (hereinafter referred to as a “camera track”) near the vehicle 1 to the controller 140. The controller 140 may perform a function of assisting a driver or driving, based on the camera track.

The radar 120 may transmit a transmission radio wave toward the perimeter of the vehicle 1, and detect an object near the vehicle 1, based on a reflection radio wave reflected from the nearby object. For example, as shown in FIG. 2, the radar 120 may be installed on a grill or bumper of the vehicle 1, and have a field of sensing 120a toward the front of the vehicle 1.

The radar 120 may include a transmission antenna (or transmission antenna array) that transmits a transmission signal, i.e., a transmission radio wave, toward the perimeter of the vehicle 1, and a reception antenna (or reception antenna array) that receives a reflection signal, i.e., a reflection radio wave, reflected from an object.

The radar 120 may obtain radar data from a transmission radio wave transmitted by the transmission antenna and a reflected radio wave received by the reception antenna. The radar data may include position information (e.g., distance information) or information about speeds of objects in front of the vehicle 1.

The driving assistance apparatus 100 may include a processor that processes radar data, and the processor may be, for example, a component included in the radar 120 or the controller 140.

The processor may generate a track corresponding to an object by obtaining radar data from the reception antenna of the radar 120 and clustering a reflection point of a reflected signal. For example, the processor may detect a distance to the track, based on the time difference between a point in time that a transmission radio wave is transmitted and a point in time that a reflection radio wave is received, and detect a relative speed of the track, based on the difference between a frequency of the transmission radio wave and a frequency of the reflection radio rave.

The processor may transmit data about a track (or a distance to and a relative speed of the track) (hereinafter referred to as “radar track”) near the vehicle 1, which is obtained from radar data, to the controller 140. The controller 140 may perform a function of assisting a driver or driving, based on the radar track.

The LiDAR 130 may transmit light (e.g., infrared light) toward the perimeter of the vehicle 1, and detect an object near the vehicle 1, based on light reflected from the nearby object. For example, as shown in FIG. 2, the LiDAR 130 may be installed on a roof of the vehicle 1 and have a field of view 120a in all directions around the vehicle 1.

The LiDAR 130 may include a transmitter (e.g., a light-emitting diode, a light-emitting diode array, a laser diode, or a laser diode array) that transmits light (e.g., infrared rays or the like), and a receiver (e.g., a photodiode or a photodiode array) that receives light (e.g., infrared rays or the like). The LiDAR 130 may further include a driving device that rotates the transmitter or the receiver as needed.

The LiDAR 130 may output light through the transmitter and receive light reflected from an object through the receiver during the rotation of the transmitter or the receiver, thereby obtaining LiDAR data.

The LiDAR data may include relative positions of objects (distances to or positions of the nearby objects) near the vehicle 1 or relative speeds of the nearby objects.

The driving assistance apparatus 100 may include a processor that processes LiDAR data, and the processor may be, for example, a component included in the LiDAR 130 or the controller 140.

The processor may generate a track corresponding to an object by clustering a reflection point due to reflected light. For example, the processor may obtain a distance to the object based on, a time difference between a point in time that light is transmitted and a point in time that light is received. In addition, the processor may detect a direction (or angle) of the object relative to a driving direction of the vehicle 1, based on a direction in which the transmitter transmits light when the receiver receives reflected light.

The processor may transmit data about a track (or a distance to and a relative speed of the track) (hereinafter referred to as “LiDAR track”) near the vehicle 1, which is obtained from LiDAR data, to the controller 140.

The controller 140 may be implemented as at least one electronic control unit (ECU) or domain control unit (DCU) electrically connected to the camera 110, the radar 120, or the LiDAR 130.

The controller 140 may process a camera track (or image data) of the camera 110, a radar track (or radar data) of the radar 120, or a LIDAR track (or LiDAR data) of the LiDAR 130, and provide a control signal to the driving device 20, the braking device 30, or the steering device 40 to control a motion of the vehicle 1. Alternatively, a control signal may be provided to the display device 50 or the audio device 60 to output a visual or audible warning to a user.

The controller 140 may include at least one memory 141 storing a program for performing an operation described below, e.g., a program for determining a state of the LiDAR 130, and at least one processor 142 configured to execute the stored program.

The memory 142 may store a program or data for processing image data, radar data, or LiDAR data. In addition, the memory 142 may store a program or data for generating a driving/braking/steering signal.

The memory 142 may temporarily store image data received from the camera 110, radar data received from the radar 120, or LiDAR data received from the LiDAR 130, and temporarily store a result of processing the image data, the radar data, or the LIDAR data by the processor 141.

The memory 142 may include a high-definition (HD) map. The HD map may include information about details of the surface of a road or an intersection, e.g., lane lines, traffic lights, intersections, and road signs, unlike general maps. In particular, landmarks (e.g., lane lines, traffic lights, intersections, road signs, etc.) encountered during the driving of the vehicle 1 are three-dimensionally displayed on the HD map.

The memory 142 may include a volatile memory such as a static random access memory (S-RAM) and a dynamic RAM (D-RAM), and a nonvolatile memory such as a flash memory, a read-only memory (ROM), and an erasable programmable ROM (EPROM).

The processor 141 may process a camera track of the camera 110, a radar track of the radar 120, or a LiDAR track of the LiDAR 130. For example, the processor 141 may fuse a camera track, a radar track, or a LIDAR track and output a fusion track.

The processor 141 may generate a driving signal, a braking signal, or a steering signal for respectively controlling the driving device 20, the braking device 30, or the steering device 40, based on a result of processing the fusion track.

For example, the processor 141 may evaluate a risk of collision between fusion tracks and the vehicle 1. The processor 141 may control the driving device 20, the braking device 30, or the steering device 40 to steer or brake the vehicle 1, based on the risk of collision between the fusion tracks and the vehicle 1.

The processor 141 may include an image processor that processes image data of the camera 110, a signal processor that processes radar data of the radar 120 or LiDAR data of the LiDAR 130, or a micro-control unit (MCU) that generates a driving/braking/steering signal.

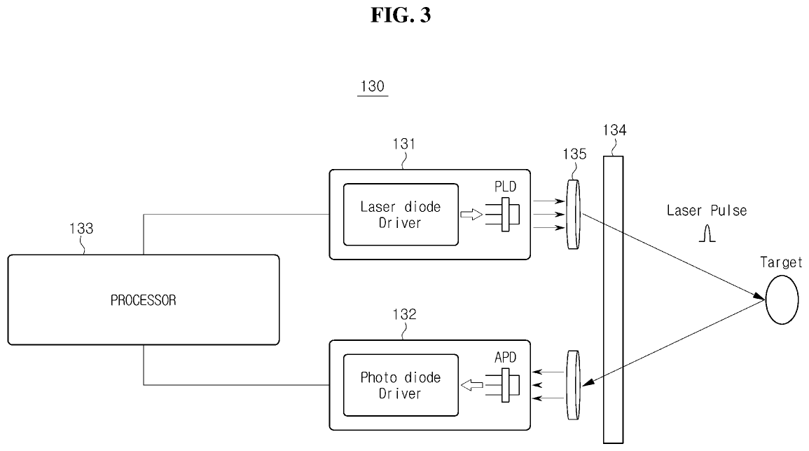

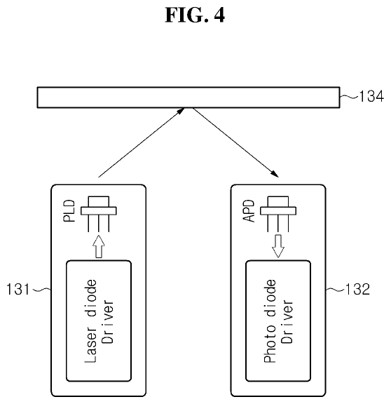

FIG. 3 is a diagram illustrating a configuration of a LiDAR included in a driving assistance apparatus according to an embodiment. FIG. 4 is a diagram illustrating a configuration of a LIDAR included in a driving assistance apparatus according to another embodiment.

Referring to FIG. 3, the LiDAR 130 may include a transmitter 131 that transmits light, a receiver 132 that receives light, and a processor 133 that adjusts the timing of light transmission and processes a reception signal.

For example, the transmitter 131 may include a pulsed laser diode (PLD) or a vertical cavity surface emitting laser (VCSEL) that outputs a laser pulse, and a driver that drives the PLD or the VSEL. The receiver 132 may include an avalanche photodiode (APD) or a single photon avalanche diode (SPAD) that receives a laser that is reflected and returned from a target, or a driver that drives the APD or the SPAD.

A lens 135 may be provided in front of each of the transmitter 131 and the receiver 132, and light output from the transmitter 131 and light reflected and returned from a target may be collected while passing through the lens 135.

Components such as the transmitter 131, the receiver 132, the processor 133, and the lens 135 described above are provided inside the housing of the LiDAR 130, light output from the transmitter 131 may be output to the outside through a window 134 of the housing, and light reflected and returned from a target may be incident on the receiver 132 through the window 134.

When the window 134 is contaminated, at least a part of light output from the transmitter 131 may not be emitted to the outside or at least a part of light reflected and returned from a target may not enter the window 134, thereby degrading the performance of the LiDAR 130.

Therefore, in order to improve stability and reliability of driving assistance using the LiDAR 130, a technique for detecting and removing the contamination of the window 134 of the LiDAR 130 is required.

Referring to FIG. 4, even when the window 134 is not contaminated, a part of light output from the transmitter 131 does not pass through the window 134 and is reflected back to the transmitter 131. The light reflected back to the transmitter 131 may include light reflected from the window 134.

Therefore, light received first by the receiver 132 immediately after the light is output from the transmitter 131 is light that does not pass through the window 134 and is reflected back to the transmitter 131. When the window 134 is not contaminated, an average intensity of light reflected back to transmitter 131 is uniform according to a position to which light from the LiDAR 130 is directed.

According to a driving assistance apparatus and a LIDAR contamination detection method of an embodiment, whether a LIDAR is contaminated may be determined, based on characteristics of light output from the transmitter 131 and reflected again into the driving assistance apparatus.

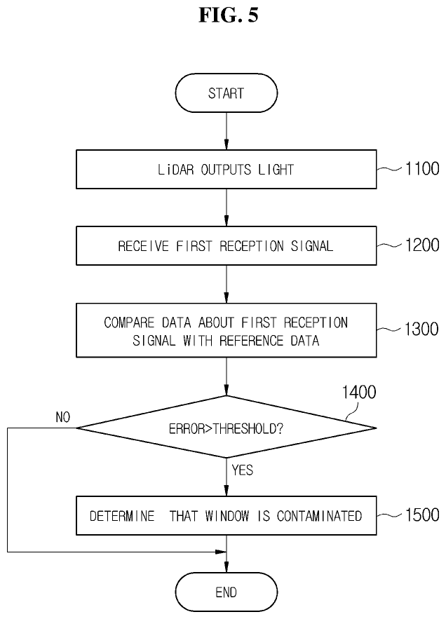

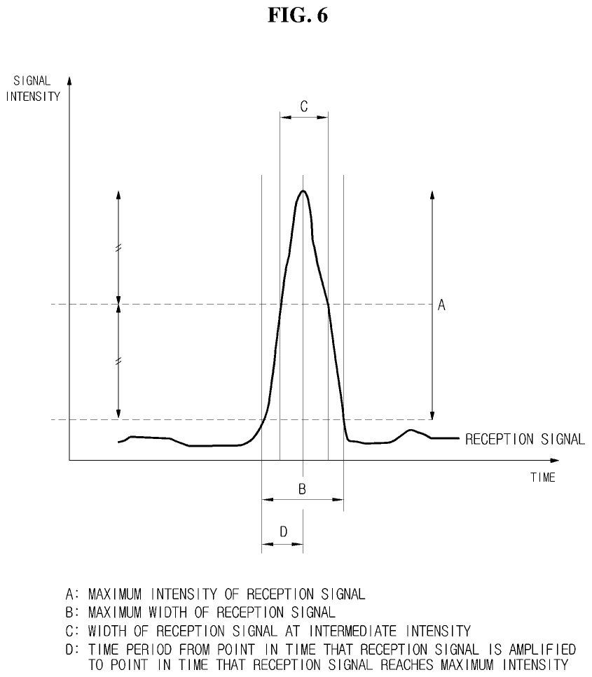

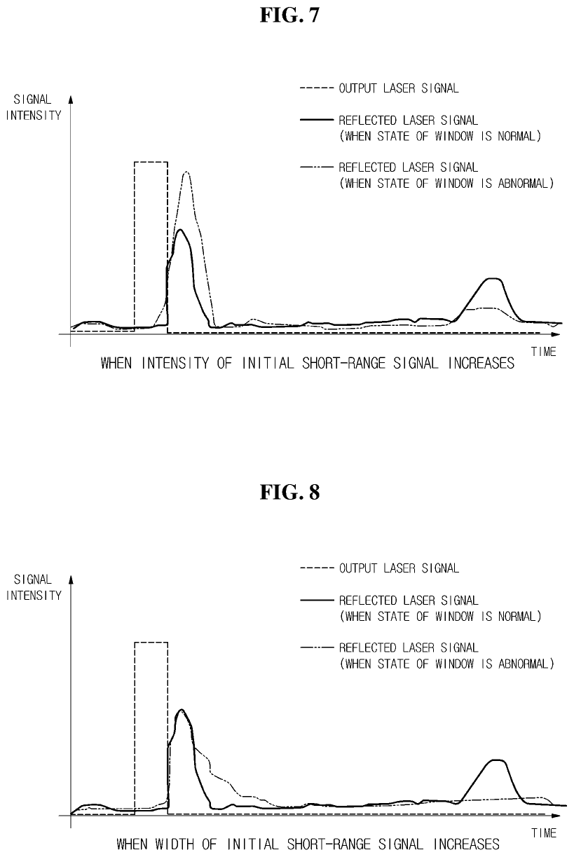

FIG. 5 is a flowchart of a LIDAR contamination detection method according to an embodiment. FIG. 6 is a diagram illustrating data that may indicate characteristics of a first reception signal received by a LIDAR. FIG. 7 is a diagram illustrating examples of a first reception signal when a window of a LIDAR is contaminated. FIG. 8 is a diagram illustrating another example of a first reception signal when a window of a LIDAR is contaminated.

In an embodiment, the LiDAR contamination detection method may be performed by the driving assistance apparatus 100 or the vehicle 1 including the driving assistance apparatus 100. Therefore, the above description of the driving assistance apparatus 100 or the vehicle 1 may apply to the LiDAR contamination detection method although not provided here. The LiDAR contamination detection method described below may also apply to the driving assistance apparatus 100 or the vehicle 1 although not described here.

Referring to FIG. 5, in an embodiment, in the LiDAR contamination detection method, the transmitter 131 of the LiDAR 130 outputs light (1100), and the receiver 132 receives a first reception signal (1200).

Here, the first reception signal may be a signal that the receiver 132 first receives immediately after the light is output from the transmitter 131. As described above with reference to FIG. 4, a signal that is first received by the receiver 132 immediately after light is output from the transmitter 131 may be a signal of light reflected and returned from the window 134 and may vary according to whether the window 134 is contaminated.

The controller 140 compares data of the first reception signal with reference data (1300), and may determine that the window 134 is contaminated (1500) when an error between the data of the first reception signal and the reference data exceeds a threshold (yes in 1400).

The data of the first reception signal may be data indicating characteristics of the first reception signal, and the reference data may be data indicating characteristics of the first reception signal measured in a state in which the window 134 is not contaminated.

In addition, the controller 140 may determine that the window 134 is contaminated, when the first reception signal is received a predetermined number of times or more, wherein an error between the data of the first reception signal and the reference data exceeds the threshold.

Referring to FIG. 6, data representing characteristics of a first reception signal may include at least one of a maximum intensity A of the first reception signal, a maximum width B of the first reception signal, an width C of the first reception signal at an intermediate intensity thereof, or a time period, i.e., an amplification time D, from a point in time that the first reception signal is amplified to a point in time that the first reception signal reaches the maximum intensity.

Data about a first reception signal received in a state in which the window 134 is not contaminated (hereinafter referred to as a first reference reception signal) or the first reference reception signal may be stored as reference data in the memory 142. That is, the reference data may include at least one of a maximum intensity of the first reference reception signal received in a state in which the window 134 is not contaminated, a maximum width of the first reference reception signal, an width of the first reference reception signal at the intermediate intensity thereof, or an amplification time of the first reference reception signal.

The controller 140 may compare at least one of the maximum intensity of the first reception signal, the maximum width of the first reception signal, the width of the first reception signal at the intermediate intensity, or the amplification time of the first reception signal with the reference data, and determine that the window 134 of the LIDAR 130 is contaminated when at least one of an error between the maximum intensity of the first reception signal and the reference data, an error between the width of the first reception signal at the intermediate intensity thereof and the reference data, or an error between the amplification time of the first reception signal and the reference data is greater than a threshold.

Referring to FIG. 7, a signal indicated by a solid line is a first reference reception signal received in a state in which the window 134 is not contaminated, and a signal indicated by a two dashed line is a first reception signal received in a state in which the window 134 is contaminated. A signal indicated by a dotted line is a laser output signal output from the transmitter 131.

When the window 134 is contaminated, a transmittance of light is lower than that of light when the window 134 is not contaminated and thus the intensity of light output from the transmitter 131 and reflected and returned from the window 134 increases.

Therefore, as shown in FIG. 7, when the window 134 is contaminated, a maximum intensity of a measured first reception signal is greater than a maximum intensity of a first reference reception signal stored in advance. When an error between the maximum intensity of the first reception signal and the maximum intensity of the first reference reception signal is greater than a threshold, the controller 140 may determine that the window 134 is contaminated.

As shown in FIG. 8, a maximum width of the first reception signal measured when the window 134 is contaminated is greater than that of the first reference reception signal stored in advance. The controller 140 compares an error between the maximum width of the first reception signal and the maximum width of the first reference reception signal with a threshold, and determines that the window 134 is contaminated when the error is greater than the threshold.

In addition, the controller 140 may compare two or more types of data with each other. For example, it may be determined that the window 134 is contaminated when at least one of the error between the maximum intensity of the first reception signal and the maximum intensity of the first reference reception signal or the error between the maximum width of the first reception signal and the maximum width of the first reference reception signal is greater than a threshold. Here, the threshold compared with the error between the maximum intensity of the first reception signal and the maximum intensity of the first reference reception signal and the threshold compared with the error between the maximum width of the first reception signal and the maximum width of the first reference reception signal may be different values or the same value.

As another example, the controller 140 may determine that the window 134 is contaminated when at least one of the error between the maximum intensity of the first reception signal and the maximum intensity of the first reference reception signal or an error between the width of the first reception signal at the intermediate intensity thereof and the width of the first reference reception signal at the intermediate intensity thereof is greater than a threshold. Here, the threshold compared with the error between the maximum intensity of the first reception signal and the maximum intensity of the first reference reception signal and the threshold compared with the error between the width of the first reception signal at the intermediate intensity thereof and the width of the first reference reception signal at the intermediate intensity thereof may be different values or the same value.

As another example, the controller 140 may determine that the window 134 is contaminated when at least one of the error between the maximum intensity of the first reception signal and the maximum intensity of the first reference reception signal, the error between the maximum width of the first reception signal and the maximum width of the first reference reception signal, or the error between the width of the first reception signal at the intermediate intensity thereof and the width of the first reference reception signal at the intermediate intensity thereof is greater than a threshold. Here, the threshold compared with the error between the maximum intensity of the first reception signal and the maximum intensity of the first reference reception signal, the threshold compared with the error between the maximum width of the first reception signal and the maximum width of the first reference reception signal, and the threshold compared with the error between the width of the first reception signal at the intermediate intensity thereof and the width of the first reference reception signal at the intermediate intensity thereof may be different values or the same value.

As another example, the controller 140 may determine that the window 134 is contaminated when at least one of the error between the maximum intensity of the first reception signal and the maximum intensity of the first reference reception signal, an error between an amplification time of the first reception signal and an amplification time of the first reference reception signal, or the error between the width of the first reception signal at the intermediate intensity thereof and the width of the first reference reception signal at the intermediate intensity thereof is greater than a threshold. Here, the threshold compared with the error between the maximum intensity of the first reception signal and the maximum intensity of the first reference reception signal, the threshold compared with the error between the amplification time of the first reception signal and the amplification time of the first reference reception signal, and the threshold compared with the error between the width of the first reception signal at the intermediate intensity thereof and the width of the first reference reception signal at the intermediate intensity thereof may be different values or the same value.

The above-described process may be performed for each piece of light output from the transmitter 131 according to a directional angle of light output from the transmitter 131 and a position of the transmitter 131 in a horizontal direction.

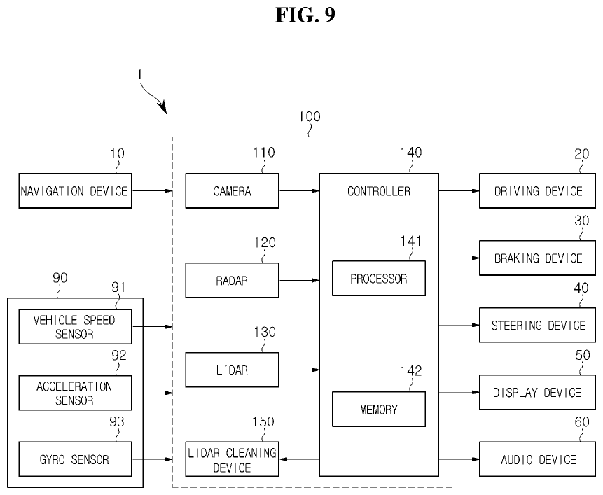

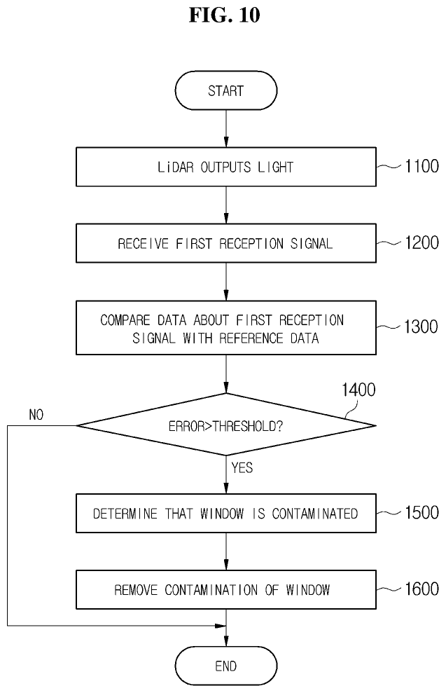

FIG. 9 is a block diagram illustrating an operation of a vehicle according to an embodiment, and FIG. 10 is a flowchart of a LIDAR contamination detection method according to an embodiment.

Referring to FIG. 9, a driving assistance apparatus 100 may further include a LiDAR cleaning device 150 for removing the contamination of a LIDAR 130.

The LiDAR cleaning device 150 may remove the contamination of the LiDAR 130, and particularly, the contamination of the window 134 of the LiDAR 130, using a wiper or a washer fluid. Alternatively, the contamination of the window 134 of the LIDAR 130 may be removed by heating the window 134. A method of removing contamination is not limited as long as the contamination of the LiDAR 130 can be removed by the LiDAR cleaning device 150.

Referring to FIGS. 9 and 10, when it is determined by the above-described process that the window 134 of the LiDAR 130 is contaminated (1500), a controller 140 may remove the contamination of the window 134 using the LiDAR cleaning device 150.

Through the above operations, the contamination of the LiDAR 130 may be accurately detected and removed, thereby preventing degradation of the performance of the LiDAR 130.

According to a driving assistance apparatus and a LIDAR contamination detection method of an embodiment, whether a LIDAR is contaminated can be determined based on a reception signal of the LiDAR, and the contamination of the LIDAR can be removed based on a result of the determination, thereby preventing degradation of the performance of the LiDAR due to the contamination thereof.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An apparatus comprising:
a Light Detection and Ranging (LiDAR) device with an area for detection of surroundings of a vehicle;
a memory storing a program for determining a state of the LiDAR device; and
a processor configured to execute the stored program,
wherein the processor is further configured to:
compare data about a first reception signal, which is received firstly after light is output from the LiDAR device, with reference data; and
determine whether the LiDAR device is contaminated based on whether an error between the data about the first reception signal and the reference data is greater than a threshold.

2. The apparatus according to claim 1, wherein the memory is configured to store, as the reference data, an intensity of a first reference reception signal received firstly after light is output from the LiDAR device in a state in which a window of the LiDAR device is not contaminated.

3. The apparatus according to claim 2, wherein the processor is further configured to:
compare an intensity of the first reception signal with the reference data stored in the memory; and
determine that the window of the LiDAR device is contaminated based on an error between the intensity of the first reception signal and the reference data being greater than the threshold.

4. The apparatus according to claim 1, wherein the memory is configured to store, as the reference data, a maximum intensity and maximum width of a first reference reception signal received firstly after light is output from the LiDAR device in a state in which a window of the LiDAR device is not contaminated.

5. The apparatus according to claim 4, wherein the processor is further configured to:
compare a maximum intensity and maximum width of the first reception signal with the reference data; and
determine that the window of the LiDAR device is contaminated based on at least one of an error between the maximum intensity of the first reception signal and the reference data or an error between the maximum width of the first reception signal and the reference data being greater than the threshold.

6. The apparatus according to claim 1, wherein the memory is configured to store, as the reference data, a maximum intensity of a first reference reception signal received firstly after light is output from the LiDAR device in a state in which a window of the LiDAR device is not contaminated and a width of the first reference reception signal at an intermediate intensity thereof.

7. The apparatus according to claim 6, wherein the processor is further configured to:
compare a maximum intensity of the first reception signal and a width of the first reception signal at an intermediate intensity with the reference data; and
determine that the window of the LiDAR device is contaminated based on at least one of an error between the maximum intensity of the first reception signal and the reference data or an error between the width of the first reception signal at the intermediate intensity and the reference data being greater than the threshold.

8. The apparatus according to claim 1, wherein the memory is configured to store, as the reference data, a maximum intensity of a first reference reception signal received firstly after light is output from the LiDAR device in a state in which a window of the LiDAR device is not contaminated, a maximum width of the first reference reception signal, and a width of the first reference reception signal at an intermediate intensity thereof.

9. The apparatus according to claim 8, wherein the processor is further configured to:
compare a maximum intensity of the first reception signal, a maximum width of the first reference reception signal, and a width of the first reception signal at an intermediate intensity with the reference data; and
determine that the window of the LiDAR device is contaminated based on at least one of an error between the maximum intensity of the first reception signal and the reference data, an error between the maximum width of the first reception signal and the reference data, or an error between the width of the first reception signal at the intermediate intensity and the reference data being greater than the threshold.

10. The apparatus according to claim 1, wherein the memory is configured to store, as the reference data, a maximum intensity of a first reference reception signal received firstly after light is output from the LiDAR device in a state in which a window of the LiDAR device is not contaminated, a width of the first reference reception signal at an intermediate intensity thereof, and an amplification time from a point in time that the first reference reception signal is amplified to a point in time that the first reference reception signal reaches the maximum intensity.

11. The apparatus according to claim 10, wherein the processor is further configured to:
compare a maximum intensity of the first reception signal, a width of the first reception signal at an intermediate intensity thereof, and an amplification time of the first reception signal with the reference data; and
determine that the window of the LiDAR device is contaminated based on at least one of an error between the maximum intensity of the first reception signal and the reference data, an error between the width of the first reception signal at the intermediate intensity and the reference data, or an error between the amplification time of the first reception signal and the reference data being greater than the threshold.

12. The apparatus according to claim 1, wherein the memory is configured to store, as the reference data, at least one of a maximum intensity of a first reception signal received firstly after light is output from the LiDAR device in a state in which a window of the LiDAR device is not contaminated, a maximum width of the first reception signal, a width of the first reception signal at an intermediate intensity thereof, or an amplification time from a point in time that the first reception signal is amplified to a point in time that the first reception signal reaches the maximum intensity.

13. A control method of an apparatus including a Light Detection and Ranging (LIDAR) device, comprising:
outputting light through the LiDAR device;
comparing data about a first reception signal, which is received firstly after the light is output from the LiDAR device, with reference data; and
determining whether the LiDAR device is contaminated based on whether an error between the data about the first reception signal and the reference data is greater than a threshold.

14. The control method according to claim 13, further comprising storing, as the reference data, an intensity of a first reference reception signal received firstly after the light is output from the LiDAR device in a state in which a window of the LIDAR device is not contaminated, and
wherein the comparing of the data about the first reception signal with the reference data comprises comparing an intensity of the first reception signal with the reference data, and
the determining of whether the window of the LiDAR device is contaminated comprises determining that the window of the LiDAR device is contaminated based on an error between the intensity of the first reception signal and the reference data being greater than the threshold.

15. The control method according to claim 13, further comprising storing, as the reference data, a maximum intensity and maximum width of a first reference reception signal received firstly after light is output from the LiDAR device in a state in which a window of the LiDAR device is not contaminated, and
wherein the comparing of the data about the first reception signal with the reference data comprises comparing a maximum intensity and maximum width of the first reception signal with the reference data, and
the determining of whether the window of the LiDAR device is contaminated comprises determining that the window of the LiDAR device is contaminated based on at least one of an error between the maximum intensity of the first reception signal and the reference data or an error between the maximum width of the first reception signal and the reference data being greater than the threshold.

16. The control method according to claim 13, further comprising storing, as the reference data, a maximum intensity of a first reference reception signal received firstly after light is output from the LiDAR device in a state in which a window of the LiDAR device is not contaminated and a width of the first reference reception signal at an intermediate intensity thereof, and
wherein the comparing of the data about the first reception signal with the reference data comprises comparing a maximum intensity of the first reception signal and a width of the first reception signal at the intermediate intensity with the reference data, and
the determining of whether the window of the LiDAR device is contaminated comprises determining that the window of the LiDAR device is contaminated based on at least one of an error between the maximum intensity of the first reception signal and the reference data or an error between the width of the first reception signal at the intermediate intensity and the reference data being greater than the threshold.

17. The control method according to claim 13, further comprising storing, as the reference data, a maximum intensity of a first reference reception signal received firstly after light is output from the LiDAR device in a state in which a window of the LiDAR device is not contaminated, a maximum width of the first reference reception signal, and a width of the first reference reception signal at an intermediate intensity thereof, and
wherein the comparing of the data about the first reception signal with the reference data comprises comparing a maximum intensity of the first reception signal, a maximum width of the first reception signal, or a width of the first reception signal at an intermediate intensity thereof with the reference data, and
the determining of whether the window of the LiDAR device is contaminated comprises determining that the window of the LiDAR device is contaminated based on at least one of an error between the maximum intensity of the first reception signal and the reference data, an error between the maximum width of the first reception signal and the reference data, or an error between the width of the first reception signal at the intermediate intensity and the reference data being greater than the threshold.

18. The control method according to claim 13, further comprising storing, as the reference data, a maximum intensity of a first reference reception signal received firstly after light is output from the LiDAR device in a state in which a window of the LiDAR device is not contaminated, a width of the first reference reception signal at an intermediate intensity thereof, and an amplification time from a point in time that the first reference reception signal is amplified to a point in time that the first reference reception signal reaches the maximum intensity, and
wherein the comparing of the data about the first reception signal with the reference data comprises comparing a maximum intensity of the first reception signal, a width of the first reception signal at an intermediate intensity thereof, and an amplification time of the first reception signal with the reference data, and
the determining of whether the window of the LiDAR device is contaminated comprises determining that the window of the LiDAR device is contaminated based on at least one of an error between the maximum intensity of the first reception signal and the reference data, an error between the width of the first reception signal at the intermediate intensity and the reference data, or an error between the amplification time of the first reception signal and the reference data being greater than the threshold.

19. The control method according to claim 13, further comprising storing, as the reference data, at least one of a maximum intensity of a first reception signal received firstly after light is output from the LIDAR device in a state in which a window of the LiDAR device is not contaminated, a maximum width of the first reception signal, a width of the first reception signal at an intermediate Intensity thereof, or an amplification time from a point in time that the first reception signal is amplified to a point in time that the first reception signal reaches the maximum intensity.
